(19) United States
(12) Patent Application Publication
(10) Pub. No.: US 2012/0330852 A1
(43) Pub. Date: Dec. 27, 2012

(54) FACILITY SAFETY AND COMPLIANCE INFORMATION SYSTEM

(76) Inventors: Peter D. Kochevar, Vancouver (CA); Randall Ray, Troy, MI (US)

(21) Appl. No.: 13/479,920

(22) Filed: May 24, 2012

Related U.S. Application Data
(60) Provisional application No. 61/489,536, filed on May 24, 2011.

(51) Int. Cl. G06Q 99/00

(52) U.S. Cl. 705/317

(57) ABSTRACT

A facility safety and compliance information system is provided as a Web-based application for managing information about deficiencies and repairs to facilities, that are subject to health and safety codes, security measures, and production and maintenance standards. The facility safety and compliance information system can maintain facility quality and keep maintenance costs in line, while also reducing liability and satisfying other regulatory constraints. The facility safety and compliance information system leverages computer information system, network, and communication technologies for automating the collection of data and the generation of regulatory and compliance documentation, while also improving the timeliness and accuracy of a facilities reporting, preparedness, and adherence to safety and compliance codes. In an exemplary embodiment of the facility safety and compliance information system, a Firestopping Information System (FIS) is provided for managing information about deficiencies and repairs to facilities that are subject to fire safety codes.

### CROSS-REFERENCE TO RELATED APPLICATIONS

This application is a non-provisional application that claims priority benefit of U.S. Provisional Application Ser. No. 61/489,536, filed May 24, 2011; the contents of which are hereby incorporated by reference.

### FIELD OF THE INVENTION

The present invention in general relates to information systems, and in particular to a Web-based application for managing information about deficiencies and repairs to facilities.

### BACKGROUND OF THE INVENTION

A firestop is a passive fire protection system of various components used to seal openings and joints in fire-resistance rated wall and/or floor assemblies, based on fire testing and certification listings. Unprotected openings in fire separations void the fire-resistance ratings of the fire separations that contain them, allowing for the spread of fire past the limits of the fire safe plan of the entire building. Firestops are designed to restore the fire-resistance ratings of rated wall and/or floor assemblies by impeding the spread of fire through the opening by filling the openings with fire resistant materials.

Penetrants, or penetrating items, are the mechanical, electrical or structural items that pass through an opening in a wall or floor, such as pipes, electrical conduits, ducting, cables and cable trays, or structural steel beams and columns. When these items pierce a wall or floor assembly, they create a space between the penetrant and the surrounding structure, which can become an avenue for the spread of fire between rooms or floors. Penetrations refer to fire code deficiencies at a facility and the subsequent repair or bringing up to code of the opening(s) of the area surrounding the penetrants

Firestops are used in accordance with a listing and approval use and compliance, which is the adherence to all the requirements of installing or using safety-related products and items in conformance with an active certification listing or approval that has been issued by an organization that is accredited both for testing and product certification. Firestopping companies are hired by property managers and owners to survey and repair fire code deficiencies in facilities

Firestopping documentation is a required element for a facility's construction site and for the continued operation of the facility once built. Firestopping documentation includes an inventory of all firestops in a building, identification tags and a separate set of drawings showing each firestop and the certification listings used for each installed firestop. Unless firestopping documentation is called for during the planning stages, created during construction and turned over in its entirety to the owner, along with comprehensive training for maintenance purposes, the facilities owner or operator has no way of knowing which hole is firestopped, and impedes the owners ability to meet the requirements of the fire code once the building is occupied. In addition, a lack of documentation makes proper repairs imprecise, which violates the fire code.

The vast amount of firestopping documentation required to properly account for the fire safety of a facility, as well as changes in a facilities condition and fire codes makes the predominantly manual process of producing firestopping documentation a tedious one that may not be accurate and up to date, which may lead to fire code violations and the development of potentially unsafe conditions.

Thus, there exists a need for a unified firestopping system that is based on information system and communication technologies that automates many of the manual processes in producing firestopping documentation, while also improving the timeliness and accuracy of a facilities fire preparedness and adherence to fire codes.

### SUMMARY OF THE INVENTION

A facility safety and compliance information system is provided as a Web-based application for managing information about deficiencies and repairs to facilities, that are subject to health and safety codes, security measures, and production and maintenance standards. The facility safety and compliance information system can maintain facility quality and keep maintenance costs in line, while also reducing liability and satisfying other regulatory constraints. The facility safety and compliance information system leverages computer information system, network, and communication technologies for automating the collection of data and the generation of regulatory and compliance documentation, while also improving the timeliness and accuracy of a facilities reporting, preparedness, and adherence to safety and compliance codes. Food service, production facilities, and utility or energy production facilities may be monitored and maintained with the facility safety and compliance information system. Food service facilities may include restaurants, food processing plants, dairy plants, and farms. Production facilities may include but are not limited to chemical, pharmaceutical, electronics, and machinery plants. In an exemplary embodiment of the facility safety and compliance information system, a Firestopping Information System (FIS) is provided for managing information about deficiencies and repairs to facilities, including but not limited to hospitals, schools, office buildings, multi-unit residences, etc., that are subject to fire safety codes.

### BRIEF DESCRIPTION OF THE DRAWINGS

FIG. 1 is a block diagram of the components of a backend server for a Firestopping Information System (FIS) according to embodiments of the invention; and

FIG. 2 is a schematic diagram illustrating an overall view of communication devices, computing devices, and mediums for a facility safety and compliance information system according to embodiments of the invention.

### DESCRIPTION OF THE INVENTION

The present invention has utility as a building maintenance tool. An inventive facility safety and compliance information system is a Web-based application for managing information about deficiencies and repairs to facilities, that are subject to health and safety codes, security measures, and production and maintenance standards. The facility safety and compliance information system can maintain facility quality and keep maintenance costs in line, while also reducing liability and satisfying other regulatory constraints.

The facility safety and compliance information system leverages computer information system, network, and communication technologies for automating the collection of data and the generation of regulatory and compliance documentation, while also improving the timeliness and accuracy of a facilities reporting, preparedness, and adherence to safety and compliance codes. Food service, manufacturing facilities, and utility or energy production facilities may be monitored and maintained with the facility safety and compliance information system. Food service facilities may include restaurants, food processing plants, dairy plants, and farms. Manufacturing facilities may include but are not limited to chemical, pharmaceutical, electronics, and machinery plants.

In an exemplary embodiment of the facility safety and compliance information system, a Firestopping Information System (FIS) is provided for managing information about deficiencies and repairs to facilities, including but not limited to hospitals, schools, office buildings, multi-unit residences, etc., that are subject to fire safety codes. The FIS is generally intended for use by firestopping companies who survey and repair fire code deficiencies in facilities for the facilities' owners, or for use by the facilities' owners who may want to manage their own firestopping information. The implementation of FIS utilizing computer information system, network, and communication technologies automates the collection of information and documentation, and replaces the current, predominantly manual process that firestopping companies and facility managers now use to collect data and generate documentation. The use of FIS improves the timeliness and accuracy of a facilities reporting, preparedness, and adherence to safety and compliance codes.

### System Architecture

Embodiments of an FIS, and by extension a facility safety and compliance information system, may include, but is not limited to, the following components and features: a database module, a Web interface, a field survey and repair module, and an Internet based electronic documentation request feature.

The database module is organized with a database schema and a structured query language (SQL)-compatible database management system through which pertinent firestopping data is stored and accessed. Alternatively, it is appreciated that a NoSQL database system is operative for use with Web-based applications such as MongoDB.

The Web interface provides password protected access to the database for use by system users such as firestopping contractors, facility managers, fire inspectors, insurance agents, or firestopping material suppliers. The Web interface is viewable with a browser on a client device display, where the Web pages are constructed in real-time by an application server that has access to the database module. Embodiments of the Web interface of the FIS include, but are not limited to the following components: an administrative Web page, a reporting module, repair estimate spreadsheets, and an archive. The administrative Web pages are provided for the use of authorized administrators to manage FIS client users, manage information about facilities including the importation of facility floor plans, and manage surveys and repairs at the facilities. The reporting module generates online reports. Online reports may include the following reports. Facility “books” are reports that correspond to specific survey and repair cycles at particular facilities. Each facility book documents “breaches”, that is, fire code deficiencies at a facility and their subsequent repair. A facility book consists of annotated floor plans for a facility, where each annotation corresponds to a firestop breach. The floor plans may be used interactively as a visual index in the same manner that geographic maps (e.g., Google Maps™) are used to find points of interest that annotate the maps. Furthermore, a survey and repair report is associated with each firestop breach. The survey and repair report can be viewed by selecting an icon that corresponds to the firestop breach location on the floor plan. A survey and repair report for a firestop breach includes a written description of the deficiency and its context within a facility, a written description of any repairs that were made at the location of the firestop breaches, before images of deficiencies, after images of repairs, and any repair documentation for the firestop breaches such as a penetration. Repair documentation may include fire integrity engineering reports for materials and products used in repairing firestop breaches. The repair reports may be provided by testing laboratories (e.g., Underwriters Laboratories, etc.), or by accredited fire safety engineers. The repair estimate spreadsheets describe each penetration and the corresponding repair, provides an estimated cost for each repair, and provides the total estimated cost for an entire facility. The archive is a repository of current and past facility books created and managed within the FIS.

The field survey and repair module is configured to allow field workers to input information regarding deficiencies and repairs for specific facilities into the facility books. The field survey and repair module is Web-based and uses the interactive facility floor plans as indexes or maps to aid field workers in reporting deficiencies and repairs. Each deficiency/repair corresponds to an icon placed on the floor plan by a field worker either manually by hand or indirectly through location based measurement of the deficiency/repair by the field worker using a device such as a global positioning system (GPS) transceiver. Furthermore, associated with each icon are digital photos of any deficiencies and repairs that are uploaded by field workers, and textual information regarding deficiencies and repairs that are entered by field workers using data entry pages. The field survey and repair module, although Web-based, functions when there is no Internet connectivity available. If the field survey and repair module loses contact with the FIS backend server, information input by field workers is put in local cache memory on the client's device. When connectivity is restored between the client device and the FIS backend server, the field survey and repair module automatically moves any cached information to the FIS database that is part of the FIS backend.

By way of example, when doing a survey of a facility, a room where there are no deficiencies yet there is a desire to record that fact while listing the date and time the room was surveyed, it specific embodiments of the present invention, a repair person in the field places a “survey mark” on a floor plan for that purpose. The survey mark icon it certain specific embodiments of the present invention has a different color than an icon for a deficiency/repair. When the survey mark icon is clicked upon, detail information about the survey for that location is displayed such as the date and time of the survey, who performed it, and optionally digital photos documenting the state of the room when it was visited. Additionally, it is appreciated that different icons are readily used in the present invention to denote different types and degrees of deficiencies or repairs that are need.

The Internet based electronic documentation request feature provides a means for authorized FIS users to request electronic documentation for products and materials used in firestop breach repairs from suppliers and manufacturers for automatic inclusion into survey and repair reports.

In embodiments of the FIS, field workers carry client devices that are Internet-capable portable computing and communications devices. The portability of the client devices provides field workers with access to the FIS from a work site at a facility when doing field surveys and repairs. Portable client devices might be laptop computers, tablet computers, smart cellular telephones, or other computing and communications devices. Generally speaking the portable client devices connect to the Internet wirelessly via local area networks (LAN), wide area networks WAN, Wifi, WIMAX, satellite, cellular telephone network, or other known or available wireless network connections.

In embodiments of the FIS, digital photos that document penetrations or the subsequent repairs of penetrations may be taken either with a separate dedicated digital camera, or with digital cameras built into the computing and communications devices carried by the field workers (e.g., a camera in a smart phone or tablet). The FIS provides field workers with an interface for uploading the digital photos into the appropriate place within a survey and repair report for a given firestop breach. If a separate dedicated digital camera is used, a field worker can create an ad hoc wireless network consisting of the camera and the computing device using some wireless standard such as WiFi or Bluetooth. Both the camera and the computing device must have wireless transceivers within them. Note that any digital camera with an SD card slot can be made WiFi-capable by using a special SD card from vendors such as Eye-Fi (http://www.eye.fi). Whenever a photo is made by a separate digital camera, the photo is automatically sent over the ad hoc wireless network to the computing and communications device where the field worker can then upload the photo into the FIS using an FIS data entry form within the uploading interface. Alternatively, the digital camera may be tethered to the client's device via a transfer cable such as a universal serial bus (USB) cable for downloading digital images. Furthermore the digital images may be automatically tagged by the camera with time and geographic coordinate information to assist in identifying locations of firestop breaches on floor plans or facility maps.

While embodiments of the FIS, and by extension a facility safety and compliance information system, are Web-based, the FIS also has an offline mode for working in the field when there is no Internet connectivity. The offline mode is virtually the same as the online mode from the viewpoint of the client users. Both the online and offline modes use a Web browser running on a client user's computing and communications device to interface with the FIS. A similar set of Web pages acting as a graphical user interface (GUI) are used whether the FIS is in online or offline mode, although from where the Web pages are generated and served is different.

In an embodiment of the FIS, a complete version of the FIS backend, including the database management system and the Web application server, is installed by client users on their portable computing and communications devices to form a local FIS backend such as laptop computers, tablet computers, or smart cellular telephones. The local FIS backends are termed “satellites” to distinguish the local FIS backends from the main FIS backend. A satellite and the main FIS backend are in communication with one another via a virtual peer-to-peer network layered on top of the Internet when a client user's computing and communications device in the field has Internet connectivity. The operation of the peer-to-peer network is transparent to the client user, who sees a single system with a single point of entry or interface to the FIS. The point of entry to the FIS is an access program that installs on the client device that initiates access to the FIS.

An embodiment of the access program performs as follows in response to a client user opening the access program and logging in. Upon logging in on the client device, a local FIS backend or satellite session is initiated on the client device, which checks to see if access to the Internet is available between the client device and the main FIS backend.

If there is Internet connectivity, the local FIS backend checks a database resident on the client user's device to see if any new data has been previously entered in an earlier offline session that has not already been uploaded to a master database in the main FIS backend on the main server. If there is new data in the client device database, a syncing operation is initiated to update the master database in the main FIS backend. The syncing operation begins by automatically logging on the client user to the main FIS backend by passing the client user's login credentials to the main FIS backend (i.e., even though the FIS system has both a main and local FIS backend a user's login name and password are the same for both). If there is no Internet connectivity, the client user remains in an offline mode. Any FIS system interactions are solely carried out with graphical user interface pages generated by the local FIS backend resident on the client device, and all new data generated is stored in the database resident on the client user's device.

Prior to going offline, a client user must cache information that the client user may require from the main FIS backend database to the database resident on their client device. In an embodiment, the FIS implementation uses a partially automated process where a client user selects on a Web page from the main FIS backend what facilities and facility books the client wants to work with offline, and the FIS automatically transfers the required data to the database resident on the client user device. In an alternative embodiment of the FIS, the transfer of data for offline operation is fully automated. That is, whenever a client user is in communication with the main FIS backend, any data in the master database in the main FIS backend that the user might possibly need if working offline that hasn't already been transferred is transferred or cached in the database resident on the client device automatically in the background while the user is working online in the foreground.

In specific embodiments of the present invention, the local FIS backend and the FIS access program are packaged together as a single installer executable file that is downloaded by an authorized client user from the main FIS Web site running on the main FIS backend server. Once downloaded, the client user installs the local FIS software one-time by running the installer on the client's device. After the installer completes the installation on the client device, the FIS system is ready for use and can be accessed by the client user when they select the FIS icon on their desktop or application screen.

Embodiments of the FIS can support multiple “engagements” using the same code base on one physical server or on multiple servers. By “engagement” is meant a client is a customer of a company or organization that runs an FIS as a cloud-based service. Each individual client engagement is given their own database even though all of the databases may use the same database schema and run on one physical database server. In the cloud-based service model, clients from different organizations or companies share resources in the cloud as an on-demand service while being totally unaware of their fellow users.

In other specific embodiments of the present invention, the FIS run as a cloud-based service, each client FIS engagement instance can be customized by FIS administrators. For instance, logos and artwork that appear on FIS Web pages may be different for each client engagement thereby reflecting the identity of the company or organization that contracts to use the FIS from the cloud-based service provider. Furthermore, the kind of information that appears on FIS Web pages and how it is collected and displayed can vary from engagement to engagement. The FIS database schema contains a variety of parameters that dictate what information should be collected and how it should be displayed. Each engagement can be customized for a client given its own unique parameter settings by FIS administrators based on the preferences of the customer contracting for the engagement. In an alternative embodiment, the client may set their parameter settings that reflect their preferences without the intervention of an FIS administrator.

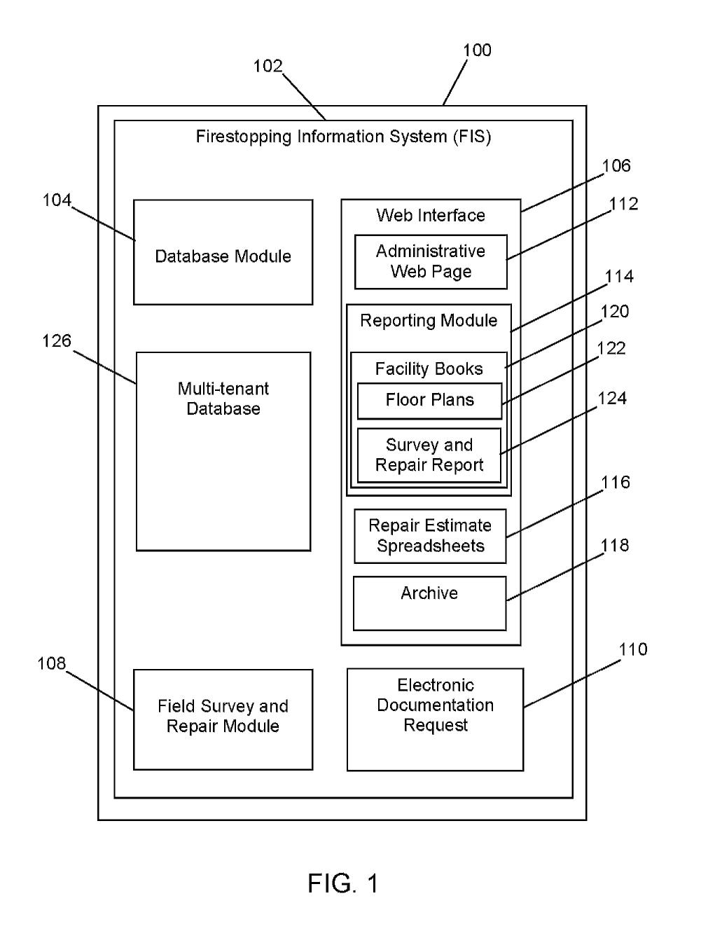

FIG. 1 is a block diagram of the components of a backend server 100 for a Firestopping Information System (FIS) 102 according to embodiments of the invention. The FIS 102, and by extension a facility safety and compliance information system, may include, but is not limited to, the following components and features: a database module 104, a Web interface 106, a field survey and repair module 108, and an Internet based electronic documentation request feature 110.

The database module 104 is organized with a database schema and a structured query language (SQL)-compatible database management system through which pertinent firestopping data is stored and accessed.

The Web interface 106 provides password protected access to the database for use by system users. The Web interface 106 is viewable with a browser on a client device display, where the Web pages are constructed in real-time by an application server that has access to the database module. Embodiments of the Web interface 106 of the FIS 102 include, but are not limited to the following components: an administrative Web 112 page, a reporting module 114, repair estimate spreadsheets 116, and an archive 118. The administrative Web pages 112 are provided for the use of authorized administrators to manage FIS client users, manage information about facilities including the importation of facility floor plans, and manage surveys and repairs at the facilities. The reporting module 114 generates online reports. Online reports may include the following reports. Facility “books” 120 are reports that correspond to specific survey and repair cycles at particular facilities. Each facility book documents “firestop breaches”, that is, fire code deficiencies at a facility and their subsequent repair. A facility book includes annotated floor plans 122 for a facility, where each annotation corresponds to a firestop breach such as a penetration. Furthermore, a survey and repair report 124 is associated with each firestop breach. The survey and repair report 124 can be viewed by selecting an icon that corresponds to the firestop breach location on the floor plan 122. A survey and repair report 124 for a penetration includes a written description of the deficiency and its context within a facility, a written description of any repairs that were made at the location of the firestop breach, before images of deficiencies, after images of repairs, and any repair documentation for the firestop breach. Repair documentation may include fire integrity engineering reports for materials and products used in repairing firestop breaches. The repair reports may be provided by testing laboratories (e.g., Underwriters Laboratories, etc.), or by accredited fire safety engineers. The repair estimate spreadsheets 116 describe each penetration and the corresponding repair, provides an estimated cost for each repair, and provides the total estimated cost for an entire facility. The archive 118 is a repository of current and past facility books created and managed within the FIS 102.

The field survey and repair module 108 is configured to allow field workers to input information regarding deficiencies and repairs for specific facilities into the facility books. The field survey and repair module 108 is Web-based and uses the interactive facility floor plans as indexes or maps to aid field workers in reporting deficiencies and repairs. Each deficiency/repair corresponds to an icon placed on the floor plan by a field worker either manually by hand or indirectly through location based measurement of the deficiency/repair by the field worker using a device such as a GPS transceiver. Furthermore, associated with each icon are digital photos of any deficiencies and repairs that are uploaded by field workers, and textual information regarding deficiencies and repairs that are entered by field workers using data entry pages. The field survey and repair module 108, although Web-based, functions when there is no Internet connectivity available. If the field survey and repair module 108 loses contact with the FIS backend server 100, information input by field workers is put in local cache memory on the client's device. When connectivity is restored between the client device and the FIS backend server 100, the field survey and repair module 108 automatically moves any cached information to the FIS client database 126 that is part of the FIS backend 102. The FIS client database 126 may be a shared multi-tenant database for use in a cloud computing configuration.

The Internet based electronic documentation request feature 110 provides a means for authorized FIS users to request electronic documentation for products and materials used in firestop breach repairs from suppliers and manufacturers for automatic inclusion into survey and repair reports.

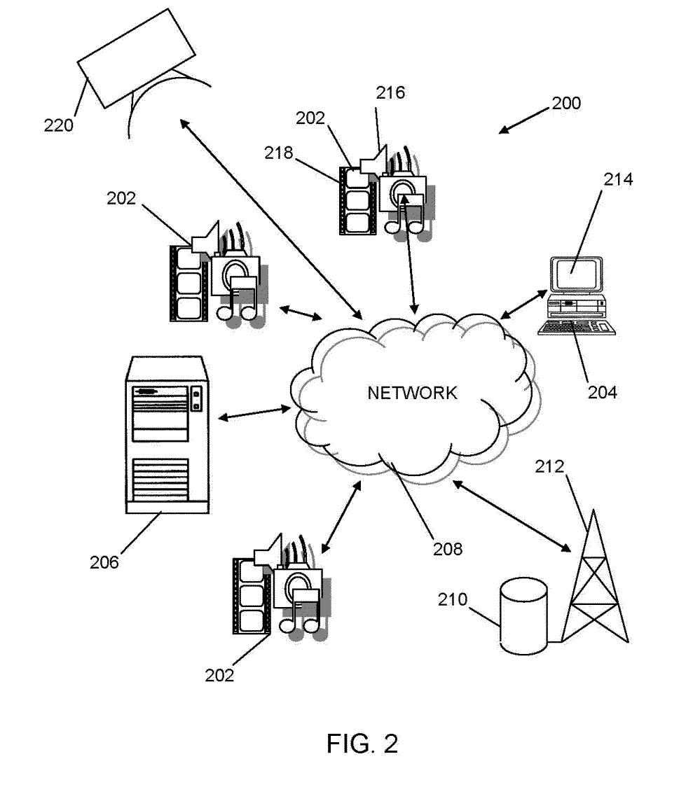

FIG. 2 is a schematic diagram illustrating an overall view of communication devices, computing devices, and mediums for a facility safety and compliance information system according to embodiments of the invention. The elements of the embodiments of the FIS in FIG. 1 are included in the networks and devices of FIG. 2.

The system 200 includes multimedia devices 202 and desktop computer devices 204 configured with display capabilities 214. The multimedia devices 202 are optionally mobile communication and entertainment devices, such as cellular phones and mobile computing devices that are wirelessly connected to a network 208. The multimedia devices 202 have video displays 218 and audio outputs 216. The multimedia devices 202 and desktop computer devices 204 are optionally configured with internal storage, software, and a graphical user interface (GUI) for carrying out elements of the facility safety and compliance information system according to embodiments of the invention. The network 208 is optionally any type of known network including a fixed wire line network, cable and fiber optics, over the air broadcasts, satellite 220, local area network (LAN), wide area network (WAN), global network (e.g., Internet), intranet, etc. with data/Internet capabilities as represented by server 206. Communication aspects of the network are represented by cellular base station 210 and antenna 212. In a preferred embodiment, the network 208 is a LAN and each remote device 202 and desktop device 204 executes a user interface application (e.g., Web browser) to contact the server system (e.g., main FIS backend 100 of FIG. 1) 206 through the network 208. Alternatively, the remote devices 202 and 204 may be implemented using a device programmed primarily for accessing network 208 such as a remote client.

The software for the facility safety and compliance information system, of embodiments of the invention, may be resident on the individual multimedia devices 202 and desktop computers 204, or stored within the server 206 or cellular base station 210. Server 206 may implement a cloud-based service for implementing embodiments of the facility safety and compliance information system with a multi-tenant database for storage of separate client data.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A facility safety and compliance information system for managing information about deficiencies and repairs to facilities comprising:
a database module with safety and compliance information;
a Web interface providing password protected access to said database for use by client users, said Web interface viewable with a browser on a client device configured with a display;
a field survey and repair module configured for said client users to input information regarding deficiencies and repairs for a facility; and
an electronic documentation request feature for said client users to request electronic documentation.

2. The system of claim 1 wherein said client device is an Internet-capable computing and communications device.

3. The system of claim 2 wherein said client device is wireless enabled and is portable.

4. The system of claim 3 wherein wireless connections are established via local area networks (LAN), wide area networks WAN, Wifi, WIMAX, satellite, cellular telephone network, or other known or available wireless network connections.

5. The system of claim 1 wherein said field survey and repair module is operative in both an online and offline mode on said client device; and
wherein in the offline mode information input by the client user is put in a local cache memory on the client's device.

6. The system of claim 5 wherein information inputted in the offline mode is automatically uploaded from the local cache on the client device to said database module that is part of a backend server of the facility safety and compliance information system.

7. The system of claim 1 wherein said database module is organized with a database schema and a structured query language (SQL)-compatible database management system.

8. The system of claim 1 wherein said Web interface provides Web pages that are constructed in real-time by an application server that has access to the database module.

9. The system of claim 1 wherein said field survey and repair module is configured for said client user to input information regarding deficiencies and repairs for specific facilities into a facility books;
wherein said field survey and repair module is Web-based and uses interactive facility floor plans as indexes or maps to aid said client user in reporting deficiencies and repairs; and
wherein an instance of a deficiency or repair corresponds to an icon placed on the floor plan by said client user either manually by hand or indirectly through location based measurement of the deficiency or repair using a device.

10. The system of claim 9 wherein said location based measurement device is a global positioning system (GPS) transceiver.

11. The system of claim 9 wherein associated with said icon placed on the floor plan are digital photos of any deficiencies and repairs that are uploaded by the client user, and textual information regarding deficiencies and repairs that are entered by the client user using one or more data entry pages.

12. The system of claim 11 wherein said digital photos are taken either with a separate dedicated digital camera, or with a digital camera built into said client device.

13. The system of claim 1 wherein said facility safety and compliance information system is configured as a Firestopping Information System (FIS).

14. The system of claim 13 wherein said database module stores firestopping data.

15. The system of claim 13 wherein said Web interface further comprises:
a series of administrative Web pages for managing said client users, managing information about said facilities including the importation of facility floor plans, and managing surveys and repairs at said facilities;
a reporting module that generates online reports including a facility book that documents firestop breaches at said facility and the subsequent repair of said firestop breaches;
a series of repair estimate spreadsheets that describe each of said firestop breaches and the corresponding repair, provides an estimated cost for each of said repair, and provides the total estimated cost for said entire facility; and
an archive that serves as a repository of current and past facility books created and managed within said FIS.

16. The system of claim 15 wherein said facility book further comprises annotated floor plans for a facility, wherein each annotation corresponds to a firestop breach.

17. The system of claim 16 wherein said floor plans are used interactively as a visual index in the same manner that geographic maps are used to find points of interest that annotate the maps.

18. The system of claim 16 wherein a survey and repair report for a particular firestop breach can be viewed by selecting an icon that corresponds to an annotation of a firestop breach location on the floor plan.

19. The system of claim 18 wherein said survey and repair report for a firestop breach comprises a written description of the deficiency and context within a facility, a written description of any repairs that were made at the location of the firestop breach, before images of deficiencies, after images of repairs, and any repair documentation for the firestop breach including a penetration; and
wherein repair documentation comprises fire integrity engineering reports for materials and products used in repairing the firestop breach.

20. A process for managing information about deficiencies and repairs to facilities using a facility safety and compliance information system of a facility comprising:
updating a database module with safety and compliance information;
providing a Web interface with password protected access to said database for use by client users, said Web interface viewable with a browser on a client device configured with a display;
providing a field survey and repair module configured for said client users to input information regarding deficiencies and repairs for a facility;
performing repairs for said facility; and
providing an electronic documentation request feature for said client users to request electronic documentation.
